(19) United States
(12) Patent Application Publication
(10) Pub. No.: US 2011/0272417 A1
(43) Pub. Date: Nov. 10, 2011

(54) CONTAINER WITH INTERNAL STRAINER

(75) Inventors: Rowdy H. Holstine, Hartford, WI (US); Jianwen Hu, Nashotah, WI (US); David G. Wood, Oregon, IL (US); Steven J. Manne, Oconomowoc, WI (US)

(73) Assignee: Silgan Containers LLC

(21) Appl. No.: 13/187,247

(22) Filed: Jul. 20, 2011

Related U.S. Application Data
(63) Continuation-in-part of application No. 13/050,446, filed on Mar. 17, 2011.
(60) Provisional application No. 61/360,633, filed on Jul. 1, 2010.
(60) Provisional application No. 61/314,746, filed on Mar. 17, 2010.

(51) Int. Cl. B65D 8/00; B23P 19/00

(52) U.S. Cl. 220/600; 29/428

(57) ABSTRACT

A container is provided including a sidewall and a strainer. The strainer is fastened to the sidewall between the first and second ends of the sidewall and located within the interior cavity of the sidewall. The strainer may be comprised of a planar sheet of material that includes a plurality of holes sized to separate liquid from solid container contents.

### CROSS-REFERENCE TO RELATED PATENT APPLICATIONS

This application is a continuation-in-part of U.S. Application No. 13/050,446, filed Mar. 17, 2011, which claims the benefit of U.S. Provisional Application No. 61/360,633, filed Jul. 1, 2010, and of U.S. Provisional Application No. 61/314,746, filed Mar. 17, 2010. The disclosures of U.S. Application No. 13/050,446, U.S. Provisional Application No. 61/360,633, and U.S. Provisional Application No. 61/314,746 are incorporated herein by reference in their entireties.

### BACKGROUND

The present invention relates generally to the field of containers. The present invention relates specifically to a container including a strainer.

### SUMMARY OF THE INVENTION

One embodiment of the invention relates to a food container including a sidewall having an inner surface, an outer surface, a first end and a second end. The sidewall defines an interior cavity. A strainer is coupled to the sidewall and is located within the interior cavity of the sidewall between the first and second ends of the sidewall. In one such embodiment, a can end wall is hermetically sealed to the first end to close the first end.

Another embodiment of the invention relates to a metal food can including a metal sidewall having an inner surface, an outer surface, a first end and a second end. An end wall is coupled to the first end of the sidewall. A planar sheet of material which includes a plurality of holes sized to separate liquid from solid container contents is coupled to the inner surface of the sidewall between the first and second ends of the sidewall.

Another embodiment of the invention relates to a method for making a metal food can having an internal strainer including the step of providing a metal tube having a sidewall, an inner surface, an upper end and a lower end. An upper flange is formed at the upper end of the metal tube and a lower flange is formed at the lower end of the metal tube. A strainer is inserted into the interior of the metal tube. The strainer is coupled to the inner surface of the metal tube such that the strainer is located in the interior of the metal tube. A can end is coupled to the upper flange.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is an exploded view of a container according to an exemplary embodiment.

FIG. 2A is a top plan view of the container of FIG. 1 according to an exemplary embodiment.

FIG. 2B is a side sectional view of the container of FIG. 1 according to an exemplary embodiment.

FIG. 3 is a perspective sectional view of the container of FIG. 1 according to an exemplary embodiment.

FIG. 4A is a detailed sectional view of a portion of the container of FIG. 1 according to an exemplary embodiment.

FIG. 4B is a detailed sectional view of a portion of the container of FIG. 1 according to another exemplary embodiment.

FIG. 4C is a detailed sectional view of a portion of the container of FIG. 1 according to another exemplary embodiment.

FIG. 5 is an exploded view of a container according to an exemplary embodiment.

FIG. 6A is a top plan view of the container of FIG. 5 according to an exemplary embodiment.

FIG. 6B is a side sectional view of the container of FIG. 5 according to an exemplary embodiment.

FIG. 7 is a perspective sectional view of the container of FIG. 5 according to an exemplary embodiment.

FIG. 8A is a detailed sectional view of a portion of the container of FIG. 5 according to an exemplary embodiment.

FIG. 8B is a detailed sectional view of a portion of the container of FIG. 5 according to another exemplary embodiment.

FIG. 9A is a sectional view of a container according to an exemplary embodiment.

FIG. 9B is a detailed sectional view of a portion of the container of FIG. 9A according to an exemplary embodiment.

FIGS. 10A-10G depict a process for making a container according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

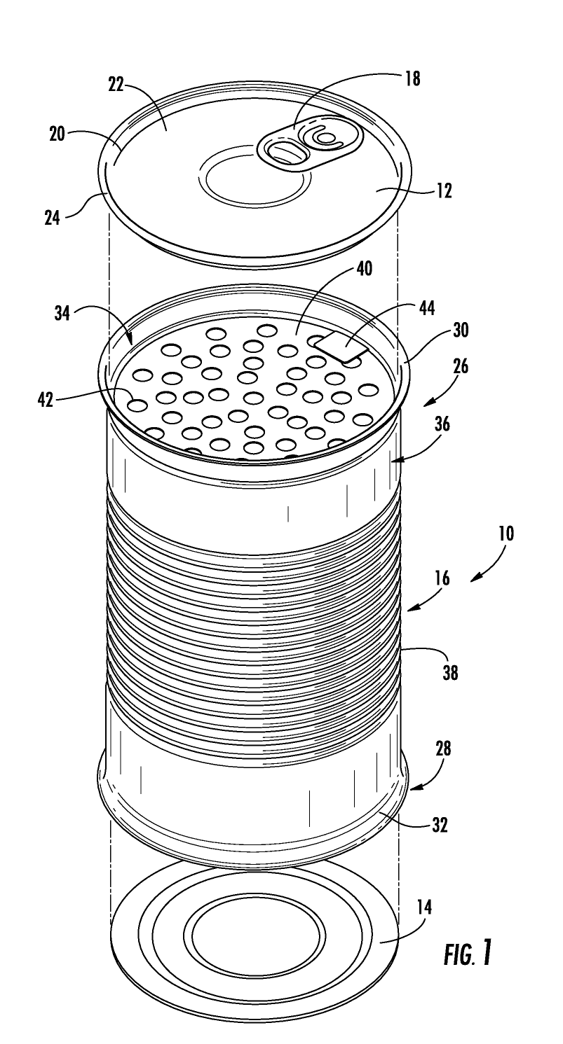

Referring to FIG. 1, an exploded view of a food container, shown as food can 10, is depicted according to an exemplary embodiment. Can 10 includes a first end wall 12, a second end wall 14 and a sidewall 16. In the embodiment of FIG. 1, first end wall 12 is shown as a pull-off can end (e.g., a “pop-top”, a “pull top”, an easy open end, a convenience end, a convenience lid, etc.). First end wall 12 may be provided with a ring or tab 18 that allows the can end to be removed without the use of a tool. Such a can end wall may include a frangible structure (e.g., a score, thin connecting metal, etc.), shown as score 20, that provides a weakness in the end wall that aids in the opening of can 10. In this embodiment, can end wall 12 includes an inner portion 22 and an outer portion 24 that are separated by score 20. To open the can, the user pulls on tab 18 causing inner portion 22 to separate from outer portion 24 along score 20. Second end wall 14 is a sanitary can end of the type that requires a tool, such as a can opener, to open.

Sidewall 16 includes a first end, shown as upper end 26, and a second end, shown as lower end 28. Sidewall 16 may be made from metal and includes an upper flange 30 defining the upper opening of the sidewall and a lower flange 32 defining a lower opening of the sidewall. The assembled or sealed can 10 is formed by coupling end wall 12 to upper end 26 of sidewall 16 and by coupling end wall 14 to lower end 28 of sidewall 16. In one embodiment, end wall 12 is coupled to sidewall 16 by folding or crimping together the material of the periphery of can end 12 with flange 30 to form a seam of interlocked portions of sidewall and can end material, and end wall 14 is coupled to sidewall 16 by folding or crimping together the material of the periphery of can end 14 with flange 32 to form a seam of interlocked portions of sidewall and can end material.

Sidewall 16 includes an inner surface 34 and an outer surface 36. Sidewall 16 includes a plurality of body beads 38. Body beads 38 are a series of inwardly extending beads centrally located on sidewall 16 that are configured to strength sidewall 16 and to allow for expansion of sidewall 16 during heating or cooking of can 10.

Can 10 includes an interior cavity defined by inner surface 34 of sidewall 16. Can 10 includes a strainer 40 positioned with the interior cavity of can 10. As shown in FIG. 1, strainer 40 is positioned within the interior cavity between upper end 26 and lower end 28 of sidewall 16.

Strainer 40 is coupled to inner surface 34 of sidewall 16. In one embodiment, strainer 40 includes a perforated sheet or plane of material that extends between opposing inner surfaces of sidewall 16 and is distinct from end wall 12. In one embodiment, strainer 40 is not coupled to sidewall 16 via a seam or double seam such as the seam that couples end wall 12 to sidewall 16.

Strainer 40 is a substantially planar piece of material that includes a plurality of holes 42. Holes 42 are sized to separate or strain liquid material (e.g., water, brine, oil, etc.) from the solid contents of can 10 (e.g., vegetables, meat, pasta, cooked vegetables, etc.). Thus, holes 42 are sized to allow liquids (or any other unwanted container contents) to pass through holes 42, but are small enough to prevent a significant portion of the solid container contents from passing through. As shown, holes 42 are substantially circular holes. However, in other embodiments, holes 42 be other shapes, including square, rectangular, elliptical, crescent, etc. Holes 42 may be sized to be smaller than the size of the average sized piece of solid container contents. In various embodiments, the diameter of holes 42 may be less than about ½ an inch, less than about a ¼ inch, between about a ¼ inch and a ½ inch, between about a ⅛ inch and a ¼ inch and/or between about 1/16 inch and ⅛ inch.

In use, can 10 is inverted following removal of can end 12 to allow liquid within can 10 to flow through holes 42. In one embodiment, the coupling between strainer 40 and sidewall 16 must be sufficiently strong such that strainer 40 can support the weight of the container contents when can 10 is in the inverted position. After the liquid has been drained, can 10 is placed right side up (i.e., with can end 14 facing downward). The user than grasps tab 44 to peel strainer 40 from inner surface 34 and to remove strainer 40 from the interior cavity of can 10. With strainer 40 removed from can 10, the user may then pour the solid contents of can 10 out through the opening located at upper end 26.

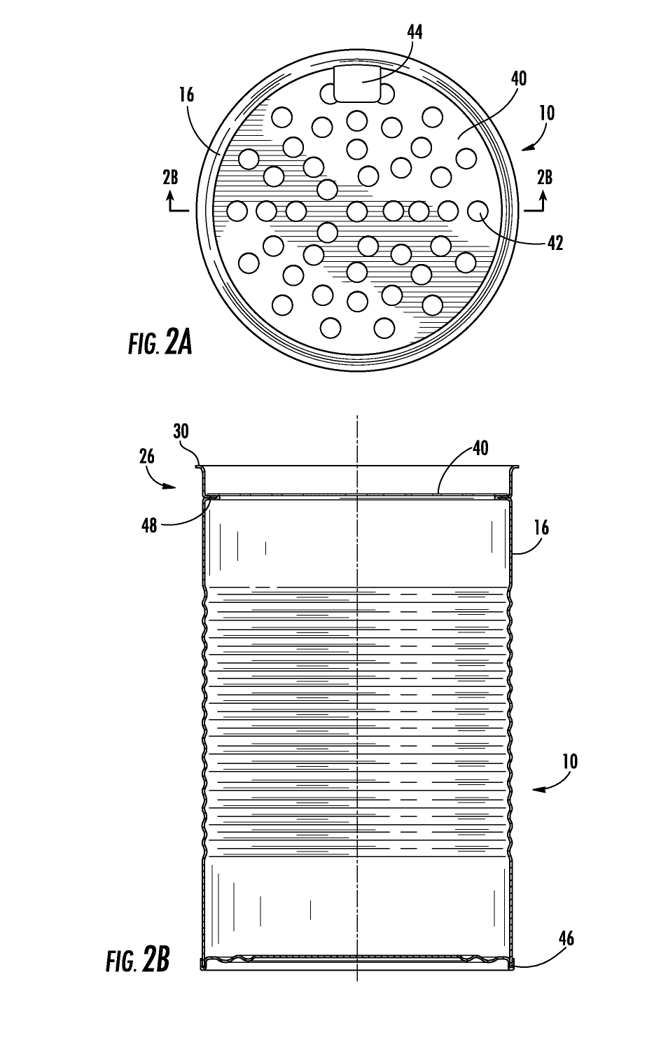

Referring to FIG. 2A, a top plan view of strainer 40 coupled to sidewall 16 is shown according to an exemplary embodiment. As shown in FIG. 2A, strainer 40 includes a plurality of holes 42 distributed substantially evenly over the surface of strainer 40. In one embodiment, holes 42 may be asymmetrically distributed over strainer 40, and, in another embodiment, holes 42 may be symmetrically distributed to form a pattern. The peripheral edge of tab 44 is coupled to strainer 40 near the strainer's peripheral edge, and the free end of tab 44 is located toward the interior of strainer 40. This arrangement allows the user to grasp tab 44 and to pull upward applying a force to the peripheral edge to remove strainer 40. With the peripheral edge of tab 44 coupled to the peripheral edge of strainer 40, the application of force via tab 44 causes the peripheral edge of strainer 40 to detach or decouple from the inner surface of sidewall 16. In one embodiment, the material of tab 44 is integral with the material of strainer 40. In one such embodiment, both tab 44 and strainer 40 are cut or punched from a large piece of material, and tab 44 is folded inward to the position shown in FIG. 2A during coupling of the strainer to can. In another embodiment, tab 44 may be a separate piece of material that is separately attached to the peripheral edge of strainer 40. In this embodiment, tab 44 may be coupled to strainer 40 via an adhesive before or after strainer 40 is coupled to the can.

FIG. 2B shows a cross-sectional view of can 10 taken along the line 2B-2B shown in FIG. 2A. FIG. 2B shows lower can end 14 coupled to sidewall 16 by seam 46 that is formed from interlocking, folding together or crimping together pieces of the sidewall and the end wall material. Can 10 includes a collapsed bead 48 formed in sidewall 16. Collapsed bead 48 extends radially inward relative to sidewall 16 and provides the surface that strainer 40 is coupled to. Collapsed bead 48 is a circumferential bead (i.e., a bead that extends completely around the perimeter of sidewall 16), and, in the embodiment shown in FIG. 2B, collapsed bead 48 is a continuous, uninterrupted circumferential bead. Collapsed bead 48 is positioned between the midpoint of sidewall 16 and upper end 26, and, specifically, is located closer to upper end 26 than to the midpoint of sidewall 16.

Referring to FIG. 3, a perspective, sectional view of can 10 is shown according to an exemplary embodiment. As shown in FIG. 3, can end 12 is coupled to sidewall 16 via a seam 50 formed by interlocking material of the upper end of sidewall 16 and can end 12. The inner surfaces of sidewall 16 and end walls 12 and 14 define an interior chamber 52 of can 10 and strainer 40 is located within interior chamber 52. In the embodiment shown in FIG. 3, strainer 40 is located a distance D below can end 12. In various embodiments, D may be between about 0.1 and 1 inches, specifically between about 0.3 and 0.8 inches and more specifically between about 0.4 and 0.6 inches. In one specific embodiment, D is about 0.5 inches.

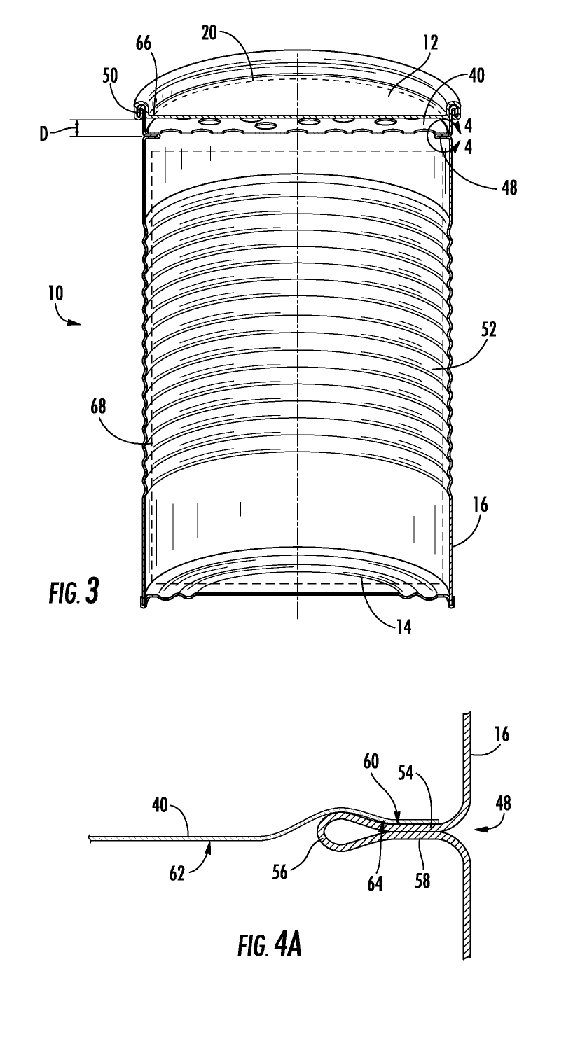

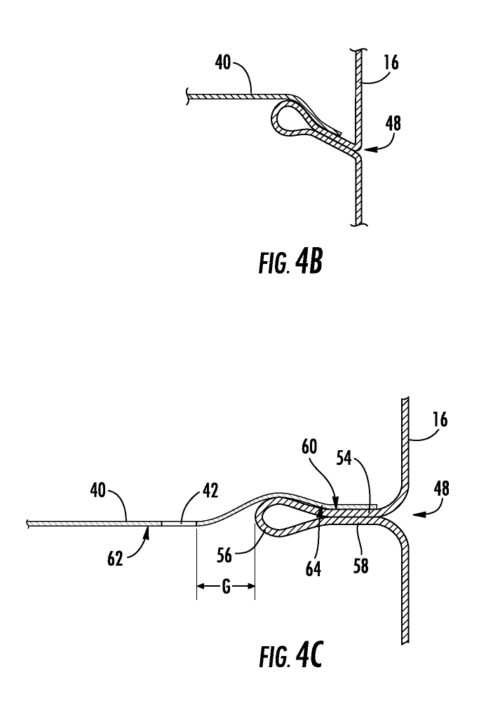

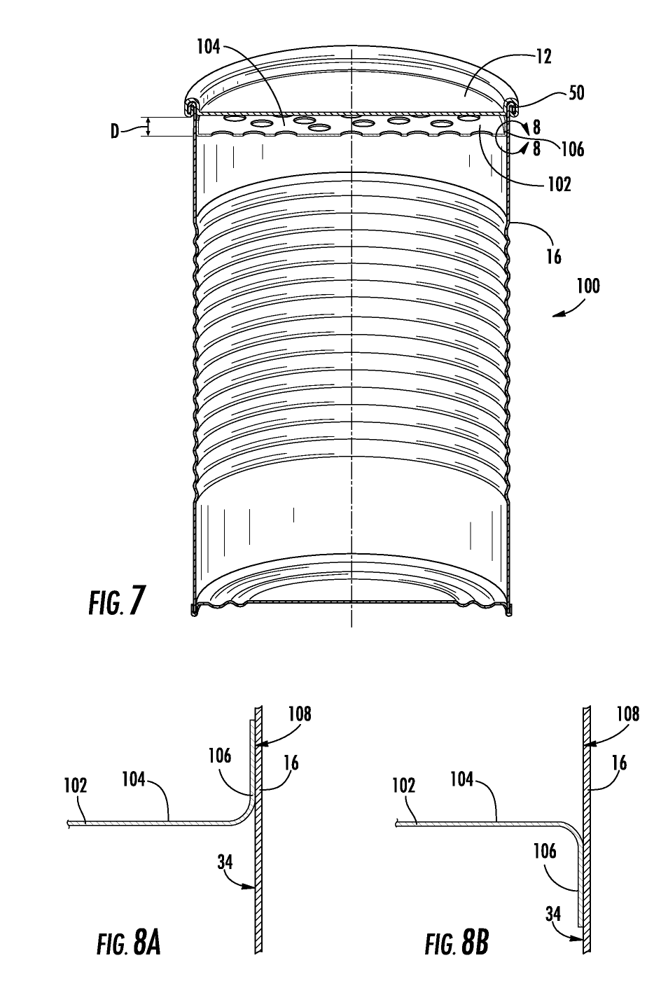

Referring to FIG. 4A, a detailed view of a portion of collapsed bead 48 and the peripheral edge of strainer 40 are shown according to an exemplary embodiment. Bead 48 is formed by crimping or collapsing portions of sidewall 16 together to form upper and lower sidewall portions or segments that extends radially inward relative to sidewall 16. Bead 48 includes an upper segment 54, an inner rounded segment 56, and a lower segment 58. Inner rounded segment 56 is a U-shaped or horseshoe-shaped segment that extends between upper segment 54 and lower segment 58 such that the greatest axial dimension (i.e., the dimension parallel to sidewall 16) of inner segment 56 is greater than the axial dimension through upper segment 54 and lower segment 58. The axial length or height of bead 48 is greater at rounded segment 56 than at segments 54 and 58 such that segment 56 is eyelet-shaped as shown in FIG. 4. However, in other embodiments, the axial dimension of rounded segment 56 is the same as or less than the axial dimension of the bead through segments 54 and 58 such that rounded segment 56 is not eyelet-shaped (similar to bead 124 as shown in FIG. 9B).

In the embodiment, shown in FIG. 4A, inner segment 56 is left rounded to limit or prevent cracking or perforation of sidewall 16 that may occur if inner segment 56 were to be crimped too tightly. Rounded inner segment 56 may also act to allow for a protective liner (e.g., an insert, coating, lining, a protective coating, sealant, etc.) to be adhered to the inner surfaces of the can.

Bead 48 includes an upper surface 60 that generally faces upper can end 12, and strainer 40 includes a lower surface 62 that generally faces lower can end 14. A peripheral portion 64 of lower surface 62 of strainer 40 contacts upper surface 60 of bead 48. Peripheral portion 64 of lower surface 62 of strainer 40 is adhered to or affixed to upper surface 60 of bead 48 to couple strainer 40 to sidewall 16.

In one embodiment, the lower surface of peripheral portion 64 includes an adhesive that couples strainer 40 to bead 48. In one embodiment, the coupling (e.g., the adhesive strength or bond strength between strainer 40 and bead 48) is sufficiently strong to support the container contents during straining and sufficiently releasable to allow the user to break the bond between the strainer 40 and bead 48 in order to remove strainer 40 via application of force to tab 44. In another embodiment, strainer 40 may include a score or other weakened material allowing the center portion of strainer 40 to break away from the portion of strainer 40 coupled to bead 48.

Strainer 40 may be made from any material suitable for straining and/or food contacting applications. In one embodiment, strainer 40 is made from a non-reactive material suitable for contacting acidic foods. Strainer 40 may be made from a laminate or foil type material that is heat sealed onto bead 48. In some embodiments, the strainer 40 is a metal foil (e.g., aluminum foil, steel foil, etc.), having a thickness substantially between 1/1000 to 1/100-inch. The metal foil includes an outer (top, outside, etc.) layer (e.g., coating) of a polymer (e.g., polyethylene terephthalate), a middle layer (e.g., substrate) of foil or other metal, and a bottom layer (e.g., 70 microns thick) of a thermoplastic (e.g., polypropylene), where the outer layers are applied via a coextrusion process. The polypropylene is configured to be heated and used as an adhesive. In this embodiment, heated polypropylene of strainer 40 is brought into contact with the upper surface of bead 48. As the polypropylene cools and solidifies, strainer 40 is bonded to bead 48. In other embodiments, the metal foil includes additional layers of different materials, and/or layers of similar materials in different arrangements (e.g., order). In still other embodiments, strainer 40 is plastic or composite (e.g., plastic foil with one or more coatings thereon) sheet of material.

Referring to FIG. 3, as noted above, first end wall 12 is shown as a pull-off can end including inner portion 22 and outer portion 24 separated by score 20. To open the can, the user pulls on tab 18 causing inner portion 22 to separate from outer portion 24 along score 20. After removal of inner portion 22 from outer portion 24 a rim 66 of material remains extending radially inward from sidewall 16. In one embodiment, strainer 40 may be coupled to the inner surface of end wall 12, and specifically, the upper surface of the portion of strainer 40 adjacent to the peripheral edge of strainer 40 may be coupled to the lower surface of rim 66. In this embodiment, the free end of tab 44 may extend radially inward beyond the free end of rim 66.

As shown in FIG. 3, can 10 may include contents 68 located in interior chamber 52. Contents 68 may be food and may include both solid components and liquid components. In one embodiment, contents 68 include a solid food product located in the space between end wall 14 and strainer 40, and strainer 40 is configured to prevent most of the solid food components from passing through strainer 40 such that substantially no solid food product is located in the space between strainer 40 and upper end wall 12.

FIG. 4A shows bead 48 extending radially inward, substantially perpendicular to sidewall 16. However, in other embodiments, bead 48 may be at a non-ninety degree angle relative to sidewall 16. For example, in one embodiment shown in FIG. 4B, bead 48 may extend radially inward and axially upward toward upper can end 12. This arrangement provides for an angled mounting surface for strainer 40 which may facilitate mounting, increase the strength of strainer 40 during filling and/or may facilitate removal of the strainer by the consumer. FIG. 4B shows bead 48 at about a 65 degree angle relative to sidewall 16 extending upward toward upper can end 12. However, in other embodiments, bead 48 may extend upward from sidewall 16 at other angles, for example 15 degrees, 30 degrees, 45 degrees, 60 degrees, 75 degrees, etc. In other embodiments, bead 48 may extend from sidewall 16 downward toward lower can end 14 at various angles (e.g., 15, 30, 45, 60, 65, 75, etc) relative to sidewall 16.

Referring to FIG. 3, the radially outermost hole 42 of strainer 40 is adjacent the innermost edge of bead 48 such that the radially outermost edges of the outermost holes 42 are above or immediately adjacent to bead 48. However, in other embodiments, the radially outermost hole 42 of strainer 40 may be spaced inwardly from the innermost edge of bead 48. In one embodiment, hole 42 may be positioned such that no portion of the radially outermost hole 42 is positioned axially above bead 48. As shown in the embodiment of FIG. 4C, outermost hole 42 is spaced from the innermost edge of bead 48 by a gap G. Gap G may be selected to ensure that holes 42 are spaced far enough from the innermost edge of bead 48 to allow for sufficient heat sealing between strainer 40 and bead 48. In one embodiment, outermost hole 42 may be positioned such that no portion of hole 42 is positioned above the heat seal formed between strainer 40 and bead 48. In one such embodiment, only a portion of strainer 40 that is positioned above bead 48 may be heat-sealed to bead 48 such that the heat seal is set back from the inner edge of bead 48. These arrangements provide a coupling between strainer 40 and bead 48 that is not interrupted by holes 42 of strainer 40.

In one embodiment, gap G may be between about zero inches and about a half inch, specifically between about zero inches and about a quarter inch, and more specifically, between a about a quarter inch and about a sixteenth of an inch. In one embodiment, gap G is about an eighth of an inch, and in another embodiment, gap G is at least an eighth of an inch. In another embodiment, gap G is between about 2 percent and 10 percent of the diameter of strainer 40, specifically is between about 3 percent and 7 percent of the diameter of strainer 40, and more specifically, is between about 3 percent and 5 percent of the diameter of strainer 40. In one embodiment, gap G is between about 4 percent and 5 percent of the diameter of strainer 40. In one embodiment, gap G is at least 3 percent of the diameter of strainer 40.

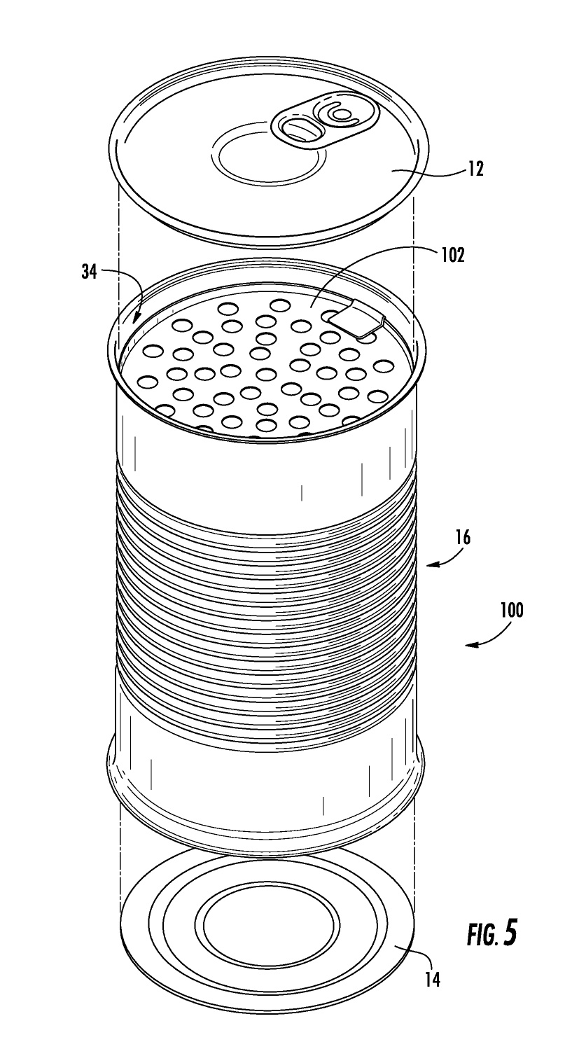

Referring to FIGS. 5-8, a container, shown as can 100, is depicted according to an exemplary embodiment. Can 100 includes a sidewall 16 and a strainer 102 coupled to the inner surface 34 of sidewall 16. Can 100 is substantially the same as can 10 except as discussed below.

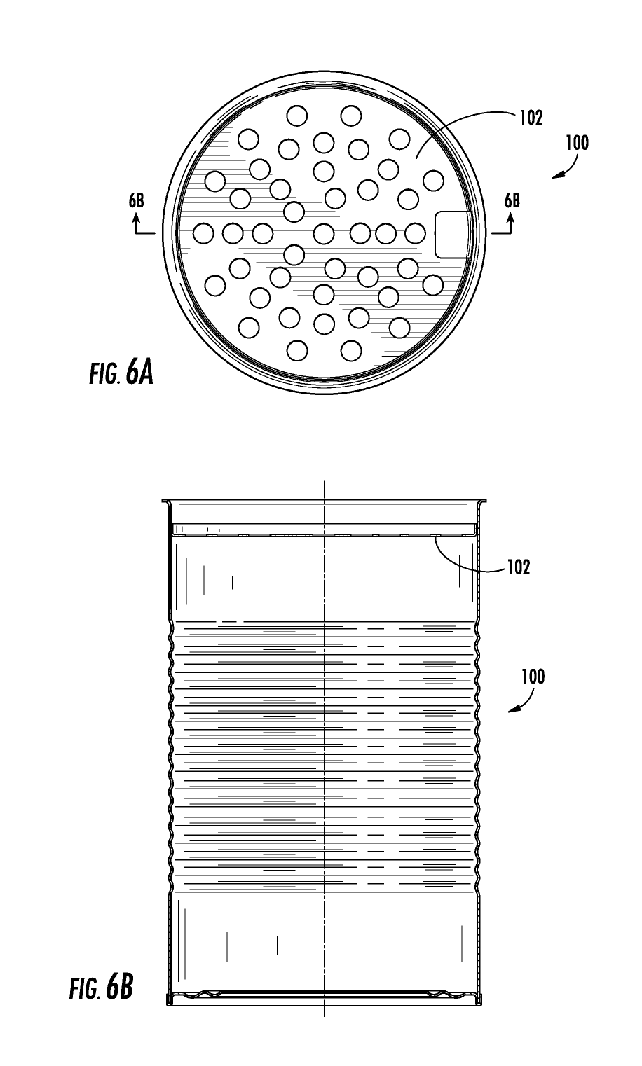

Referring to FIG. 7 and FIGS. 8A and 8B, strainer 102 is shown coupled to a substantially vertical portion of sidewall 16 (as opposed to being coupled to the upper surface of bead 48). In this embodiment, strainer 102 includes an inner portion 104 that extends across the inner cavity of can 100 and is positioned substantially parallel to can end 12. Strainer 102 also includes an upstanding ring portion 106 that is coupled to the peripheral edge of inner portion 104 and extends upward toward upper can end 12. In one embodiment shown in FIG. 8B, ring portion 106 is coupled to the peripheral edge of inner portion 104 and extends downward toward lower can end 14. Ring portion 106 includes a radially outward facing surface 108 that is in contact with inner surface 34 of sidewall 16. As shown, upstanding ring portion 106 is substantially perpendicular to inner portion 104, and outward facing surface 108 is substantially parallel to sidewall 16. In this embodiment, outward facing surface 108 may include an adhesive configured to bond to inner surface 34 to couple strainer 102 to sidewall 16.

In other embodiments, a strainer, such as strainers 40 or 102, may be positioned or supported within the interior cavity of sidewall 16 via other mechanisms. For example, in one embodiment, the peripheral section of the material of the strainer may be positioned between the material of the sidewall and can end within end seam 50. Thus, in this embodiment, the strainer may be coupled to sidewall 16 via the interlocking of material that occurs within the end seam. In one such embodiment, the planar piece of foil or laminate material that forms the strainer may be positioned close to or in contact with the lower surface of can end 12 such that distance D is substantially zero.

Referring to FIG. 9, a container 120 is shown according to an exemplary embodiment. Container 120 includes an internal strainer 122 coupled to a collapsed bead 124 formed in sidewall 126 of container 120. Container 120 includes a pull-off, upper can end 128 and a lower can end 130 both coupled to sidewall 126 by a seam as discussed above.

Pull-off, upper can end 128 includes an inner portion 132, an outer portion 134, a weakened area, shown as score line 136, and a tab 138. Tab 138 is coupled to inner portion 132. To open can 120, the user grasps tab 138 and pulls upward causing inner portion 132 to separate from outer portion 134 along score line 136. With inner portion 132 removed, the contents of the container may be accessed through the opening left by inner portion 132. Outer portion 134 remains coupled to sidewall 126 following removal of inner portion 132 leaving a rim or lip 142 extending toward the interior of the container.

Container 120 includes an additional bead, shown as guard bead 140, formed in sidewall 126. Guard bead 140 is formed in sidewall 126 and is positioned above strainer 122 and below upper can end 128 or between strainer 122 and upper can end 128. Guard bead 140 is also positioned above collapsed bead 124 and below upper can end 128 or between collapsed bead 124 and upper can end 128. As noted above, after the liquid within the container is drained using strainer 122, the user then reaches through the upper opening of the can to grasp the strainer tab to remove the strainer providing access to the solid contents of the container. Guard bead 140 acts to limit or prevent contact between a user's fingers and rim 142 during removal of the strainer.

Referring to FIG. 9B, guard bead 140 includes an upper segment 144, a rounded inner segment 146 and a lower segment 148. Rounded inner segment 146 has a convex curved inner surface that provides for a rounded and non-sharp contact surface. Guard bead 140 extends radially inward relative to sidewall 126 a distance L1, and rim 142 extends radially inward relative to sidewall 126 a distance L2. In one embodiment, guard bead 140 acts to space a user's finger away from the inner edge of rim 142. In this embodiment, L1 is greater than L2. In another embodiment, L2 is greater than L1, and, in this embodiment, rounded inner segment 146 acts to effectively “blunt” the inner edge of rim 142 by having rounded inner segment 146 located adjacent to rim 142 in effect increasing the axial length of rim 142.

In various embodiments, tab 44 of the strainer may be configured or positioned as to limit or prevent inadvertent contact between rim 66 (shown in FIG. 3) or rim 142 (shown in FIG. 9B) and the user's fingers. In one embodiment, the inner most free end of tab 44 extends radially inward further than the inner most edge of rim 66 or of rim 142. In another embodiment, instead of tab 44 being positioned substantially parallel to strainer 40 as shown in FIG. 1, tab 44 runs up the inner surface of sidewall 16 and along the lower surface of rim 66 or rim 142 such that the free end of tab 44 extends beyond the inner most edge of rim 66 or rim 142. In one embodiment, tab 44 may be positioned in the center of strainer 40 such that the user's fingers do not need to be near the rim 66 or 142 when interacting with tab 44.

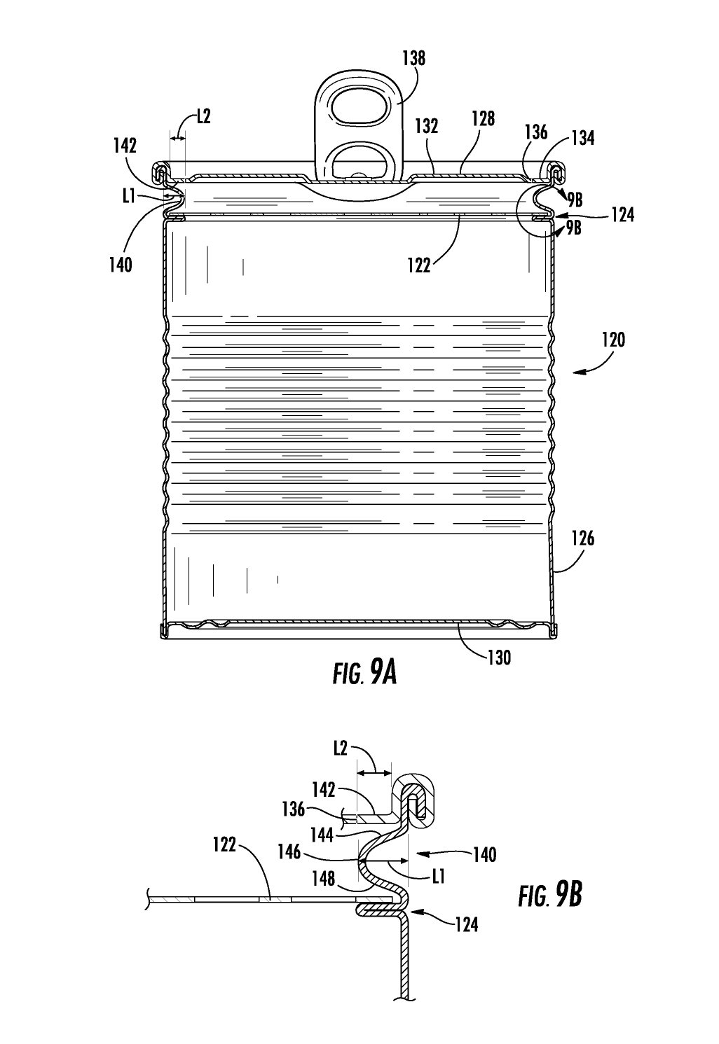

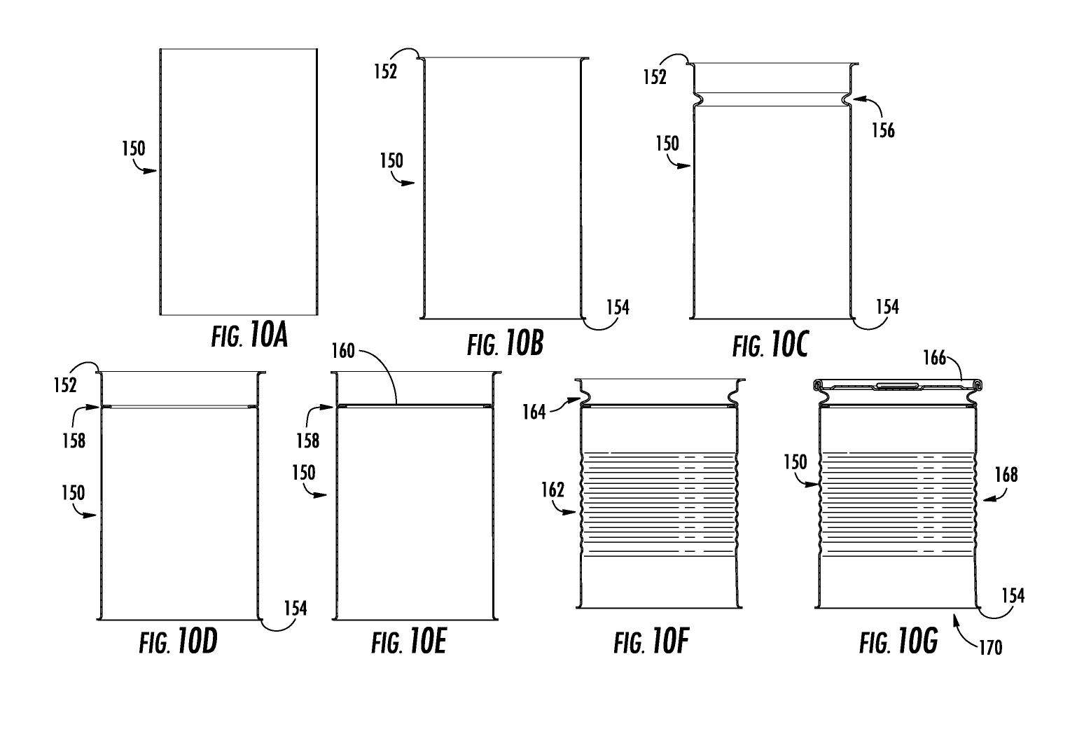

Referring to FIGS. 10A-10G, a process for making a metal container, such as can 10, can 100, can 120, is shown according to an exemplary embodiment. At the step shown in FIG. 10A, a metal tube, shown as can blank 150, is provided. At the step shown in FIG. 10B, upper flange 152 is formed at the upper end of blank 150, and lower flange 154 is formed at the lower end of blank 150. At the step shown in FIG. 10C, a bead (e.g., a non-collapsed bead) 156 is formed in the sidewall of can blank 150 near upper flange 152. At the step shown in FIG. 10D, a collapsed bead 158 is formed from bead 156. In one embodiment, an upper tool enters the open upper end of can blank 150, and a lower tool enters the open lower end of can blank 150. In this embodiment, bead 156 is compressed into collapsed bead 158 between the upper tool and the lower tool.

At the step shown in FIG. 10E, a strainer 160 is coupled to the upper surface of collapsed bead 158. To couple strainer 160 to collapsed bead 158, a tool enters the upper end of can blank 150 to deliver strainer 160 to collapsed bead 158 and to adhere strainer 160 to collapsed bead 158. In one embodiment, strainer 160 includes a thermoplastic layer or coating on the surface facing collapsed bead 158, and strainer 160 is heated and pressed onto collapsed bead 158 using an appropriate tool (e.g., a heated press). The heated thermoplastic material of strainer 160 melts and is subsequently allowed to cool and solidify bonding strainer 160 to bead 158.

At the step shown in FIG. 10F, body beads 162 and guard bead 164 are formed along the sidewall of can blank 150. In one embodiment, the container may not include guard bead 164. At step shown in FIG. 10G, upper can end 166 is coupled to upper flange 152 to produce a can 168 that is ready for filling with product through the open lower end 170. In one embodiment, can 168 having an open end that opposes strainer 160 may be provided from a can manufacturer to a food company (e.g., a filler, a packer, etc.) that fills can 168 with a food product via open lower end 170. Once can 168 is filled, a lower can end is coupled to lower flange 154 in the manner discussed above to seal the can contents within the can.

The containers discussed herein may be formed from any material, including metals, plastics, ceramics and glasses. According to an exemplary embodiment, the containers discussed herein are formed from metal, such as tin-coated steel or aluminum. In some embodiments, the containers discussed herein are formed from aluminum and the can ends are formed from tin-coated steel. In other embodiments, other metals or materials (e.g., polymers, high-temperature plastic, thermoplastics, cardboard, ceramic, etc.) are used to form some or all of the container.

Containers discussed herein may include containers of any style, shape, size, etc. For example, the containers discussed herein may be shaped such that cross-sections taken perpendicular to the longitudinal axis of the container are generally circular. However, in other embodiments the sidewall of the containers discussed herein may be shaped in a variety of ways (e.g., having other non-polygonal cross-sections, as a rectangular prism, a polygonal prism, any number of irregular shapes, etc.) as may be desirable for different applications or aesthetic reasons. In various embodiments, the sidewall of can 10 may include one or more sections that are curved in the axial direction or may include one or more sections that are continuously curved in the axial direction. In one embodiment, can 10 may be hourglass shaped. Can 10 may be of various sizes (e.g., 3 oz., 8 oz., 12 oz., 15 oz., 28 oz, etc.) as desired for a particular application.

Further, a container may include a container end (e.g., a closure, lid, cap, cover, top, end, can end, sanitary end, “pop-top”, “pull top”, convenience end, convenience lid, pull-off end, easy open end, “EZO” end, etc.). The container end may be any element that allows the container to be sealed such that the container is capable of maintaining a hermetic seal. In an exemplary embodiment, the upper can end may be an “EZO” convenience end, sold under the trademark “Quick Top” by Silgan Containers Corp.

The upper and lower can ends discussed above are shown as “double seams” formed from the interlocked portions of material of the can sidewall and the can end. However, in other embodiments, the can ends discussed herein may be coupled to the sidewall via other mechanisms. For example, can ends may be coupled to the sidewall via welds or solders. As shown above, the containers discussed herein are three-piece cans having an upper can end, a lower can end and a sidewall each formed from a separate piece of material. However, in other embodiments, a two-piece can (i.e., a can including a sidewall and an end wall that are integrally formed and a separate can end component joined to the sidewall via a double seam) may be provided with an internal strainer as discussed herein.

In various embodiments, the upper can end may be a closure or lid attached to the body sidewall mechanically (e.g., snap on/off closures, twist on/off closures, tamper-proof closures, snap on/twist off closures, etc.). In another embodiment, the upper can end may be coupled to the container body via an internal vacuum. The container end may be made of metals, such as steel or aluminum, metal foil, plastics, composites, or combinations of these materials. In various embodiments, the can ends, double seams, and sidewall of the container are adapted to maintain a hermetic seal after the container is filled and sealed.

The containers discussed herein may be used to hold perishable materials (e.g., food, drink, pet food, milk-based products, etc.). It should be understood that the phrase “food” used to describe various embodiments of this disclosure may refer to dry food, moist food, powder, liquid, or any other drinkable or edible material, regardless of nutritional value. In other embodiments, the containers discussed herein may be used to hold non-perishable materials or non-food materials. In various embodiments, the containers discussed herein may contain a product that is packed in liquid that is drained from the product prior to use. For example, the containers discussed herein may contain vegetables, pasta or meats packed in a liquid such as water, brine, or oil.

During certain processes, containers are filled with hot, pre-cooked food then sealed for later consumption, commonly referred to as a “hot fill process.” As the contents of the container cool, a vacuum develops inside the container. In embodiments using a vacuum attached closure, the resulting vacuum may partially or completely secure the closure to the body of the container. During other processes, containers are filled with uncooked food and are then sealed. The food is then cooked to the point of being commercially sterilized or “shelf stable” while in the sealed container. During such a process, the required heat and pressure may be delivered by a pressurized heating device or retort.

According to various exemplary embodiments, the inner surfaces of the upper and lower can ends and the sidewall may include a liner (e.g., an insert, coating, lining, a protective coating, sealant, etc.). The protective coating acts to protect the material of the container from degradation that may be caused by the contents of the container. In an exemplary embodiment, the protective coating may be a coating that may be applied via spraying or any other suitable method. Different coatings may be provided for different food applications. For example, the liner or coating may be selected to protect the material of the container from acidic contents, such as carbonated beverages, tomatoes, tomato pastes/sauces, etc. The coating material may be a vinyl, polyester, epoxy, EVOH and/or other suitable lining material or spray. The interior surfaces of the container ends may also be coated with a protective coating as described above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A food container comprising:
a sidewall including an inner surface, an outer surface, a first end and a second end, the sidewall defining an interior cavity;
a can end wall hermetically sealed to the first end to close the first end; and
a strainer coupled to the sidewall within the interior cavity of the sidewall adjacent to the can end wall.

2. The food container of claim 1, further comprising:
a bead formed in the sidewall between the first and second ends of the sidewall, the bead extending radially inward relative to the sidewall, wherein the strainer is coupled to the bead.

3. The food container of claim 2, wherein the bead includes an upper surface facing the end wall, wherein the strainer includes a lower surface facing the second end of the sidewall, wherein a portion of the lower surface of the strainer contacts and adheres to the upper surface of the bead.

4. The food container of claim 3, wherein the bead is a circumferential, compressed bead and the strainer comprises a planar sheet of material including a plurality of holes, wherein the peripheral edge of the strainer is adhered to the upper surface of the bead.

5. The food container of claim 1, wherein the strainer includes a surface that contacts and adheres to the inner surface of the sidewall.

6. The food container of claim 5, wherein the strainer comprises a planar sheet of material including a plurality of holes and an upstanding ring of material coupled to the peripheral edge of the planar sheet such that the upstanding ring of material is substantially perpendicular to the planar sheet, and further wherein the surface of the strainer that contacts the inner surface of the sidewall is a radially outward facing surface of the upstanding ring.

7. The food container of claim 1, further comprising a tab extending from an upper surface of the strainer, and further wherein the strainer is removably coupled to the sidewall such that the application of an upward force to the tab causes the strainer to decouple from the sidewall.

8. The food container of claim 1, wherein the strainer includes a plurality of holes that are sized such that liquid within the container may flow through the holes while preventing the majority of the container contents from passing through the holes.

9. The food container of claim 1, further comprising a filling opening defined by the second end of the sidewall.

10. The food container of claim 1, further comprising:
a first end wall coupled to the first end of the sidewall;
a second end wall coupled to the second of the sidewall; and
a solid food product located in the space between the second end wall and the strainer, and substantially no solid food product located in the space between the strainer and the first end wall.

11. A metal food can comprising:
a metal sidewall including an inner surface, an outer surface, a first end and a second end;
an end wall coupled to the first end of the sidewall; and
a planar sheet of material including a plurality of holes sized to separate liquid from solid container contents, wherein the planar sheet of material is coupled to the inner surface of the sidewall between the first and second ends of the sidewall.

12. The metal food can of claim 11, further comprising a filling opening defined by the second end of the sidewall, wherein the end wall is a sanitary end coupled to the sidewall via a seam of interlocked portions of sidewall and end wall material.

13. The metal food can of claim 11, further comprising a filling opening defined by the second end of the sidewall, wherein the end wall is a pull-off can end comprising:
an inner, removable portion;
a tab coupled to the inner portion;
an outer portion surrounding the inner portion; and
a score line separating the inner portion from the outer portion;
wherein the pull-off can end is coupled to the sidewall via a seam, the seam formed of interlocked portions of sidewall and end wall material;
wherein the inner portion of the can end may be separated from the outer portion along the score line to access contents of the container.

14. The metal food can of claim 13, further comprising a guard bead formed in the sidewall, the guard bead positioned between the planar sheet of material and the end wall.

15. The metal food can of claim 11, wherein the sidewall includes a center point, and further wherein the planar sheet of material is located between the center point and the first end of the sidewall and closer to the first end than to the center point.

16. The metal food can of claim 11, wherein a peripheral section of the planar sheet is coupled to the sidewall by an adhesive material, and further wherein the planar sheet comprises at least one of a laminate material, a foil material and a thermoplastic material.

17. The metal food can of claim 11, wherein the planar sheet is one of laminate material and a foil material.

18. A method for making a metal food can having an internal strainer comprising:
providing a metal tube including a sidewall, an inner surface, an upper end and a lower end;
forming an upper flange at the upper end of the metal tube and a lower flange at the lower end of the metal tube;
attaching the strainer to the inner surface of the metal tube such that the strainer is located in the interior of the metal tube; and
coupling a can end to the upper flange.

19. The method of claim 18, further comprising forming a compressed bead in the sidewall, wherein the strainer is inserted into the interior of the metal tube through the upper end and is coupled to a surface of the compressed bead via an adhesive material.

20. The method of claim 18, wherein the strainer includes a radially outward facing surface, wherein the radially outward facing surface is adhered to the inner surface of the metal tube via an adhesive material coupling the strainer to the tube.
